(19) United States
(12) Patent Application Publication
(10) Pub. No.: US 2009/0230679 A1
(43) Pub. Date: Sep. 17, 2009

(54) Pipe Connection

(76) Inventors: Josef Mocivnik, Fohnsdorf (AT); Alfred Wagner, Linz (AT)

Correspondence Address: JACOBSON HOLMAN PLLC, 400 SEVENTH STREET N.W., SUITE 600, WASHINGTON, DC, 20004, US

(21) Appl. No.: 11/921,044

(22) PCT Filed: May 26, 2006
(86) PCT No.: PCT/AT2006/000215

§ 371 Date: Nov. 26, 2007

(30) Foreign Application Priority Data
May 27, 2005 (AT) GM 350/2005

(51) Int. Cl. F16L 15/00

(52) U.S. Cl. 285/390

(57) ABSTRACT

Disclosed is a connection between two pipes (1, 2) in which a final section of one pipe overlaps a final section of the other pipe or one respective joining element (3, 4) is inserted into the facing final sections of the pipes (1, 2). The pipes (1, 2) can be screwed together. The final section of the pipe that is overlapped by the other pipe, or at least one joining element (3, 4) that is inserted into a final section (3, 4), is embodied with an area (18, 19) having a lower rigidity than the adjoining subarea at the end facing the interior of the pipe. Said area (18, 19, 30) having a reduced rigidity is embodied with a least one depression or recess (20, 21, 21′, 31) on the inner circumference thereof, whereby one is able to ensure that the pipes (1, 2) that are to be interconnected remain undamaged if the same are tilted or inclined relative to each other, even in case forces act eccentrically upon the pipe connection.

The present invention relates to a pipe connection between a first pipe and a second pipe, wherein an end section of one pipe is overlapped by an end section of the other pipe and/or a joining element is each inserted in the mutually facing end sections of the pipes, and wherein the pipes are, in particular, detachably connectable, preferably screwable, with each other, whereby the end section of the pipe overlapped by the other pipe, and/or at least one joining element inserted in an end section of a pipe, is formed with an area of reduced strength relative to an adjoining subarea on its end facing the interior of the pipe, wherein the area of reduced strength is provided with a plurality of depressions or recesses on its inner circumference.

In the context of pipe connections provided between a first pipe and a second pipe, different embodiments are known, wherein, for instance, an end section of a pipe enters an end section of a pipe to be connected with the former so as to be overlapped by the same, with a connection being, moreover, provided between the pipes. In the case of a detachable connection, a screw connection using appropriate threads is, for instance, provided. Alternatively, it is also possible to glue, weld or otherwise join pipes to be connected, such a connection being usually inseparable without destruction. In addition, it is known to insert into end sections of pipes or pipe elements to be connected with each other, joining elements which are to be connected with each other, wherein, in particular, a detachable connection will again, for instance, be realized by a screw connection or a bayonet catch.

When producing anchorages or pipe shields for the production of tunnels or general passageways in rock or soil material, such anchorages or pipe shields are usually each produced by the drilling of a hole over a predefined length, whereupon appropriate pipe extensions are provided to obtain optionally great lengths of such anchorages or pipe shield elements for proper securement. When producing such anchorages or pipe shields, it is, furthermore, to be anticipated that, for instance, due to different soil or rock material, shifts between individual soil or rock layers may partially occur, which may cause stresses or strains on anchorages or elements of pipe shields transversely or obliquely to the longitudinal extension of such a pipe-shaped element. If such stresses occurring obliquely or transversely to a longitudinal extension or axis of the pipe-shaped element occurs in the region of a connection of adjoining pipes or pipe elements, it may happen, in particular where the mutually engaging or superimposed end sections of the pipes or pipe elements to be connected are in direct contact with each other, that the inwardly located, optionally sharp-edged end section of one pipe damages and eventually destroys the surrounding end section of the other pipe such that the desired integrity of the entire pipe-shaped element will no longer be given, or affected, in the region of this connection. If such a pipe-shaped element comprised of several pipes or pipe elements is used as an anchorage or element of a pipe shield, the protection to be achieved will, thereby, be directly influenced or no longer be given.

Embodiments of pipe connections, wherein a weakening is provided in the area of an inner end of the pipe connection to avoid a damaging or destruction of the surrounding pipe portion during a small inclination can for example be taken from EP-A 0 032 265, GB-A 758 333 or U.S. Pat. No. 6,752,436.

Moreover a pipe connection according to the type mentioned above can be taken from U.S. Pat. No. 2,239,942, wherein two depressions are provided in a front end portion of the inner end portion being surrounded or overlapped by the other pipe, which runs in a circumferential direction wherein a securing ring can be put into one of the depressions for allowing an adjustment of the resilience or elasticity of the inner end portion or section.

Departing from a pipe connection of the initially defined kind, the present invention aims to further develop the same to the extent that the integrity of the connection and, in particular, of a jacket area of an end section overlapping the respectively other pipe will be safeguarded even in the event of eccentric stress or strain acting transversely or obliquely to the longitudinal axis of the pipe connection between a first pipe and a second pipe.

To solve these objects, a pipe connection of the initially defined kind is essentially characterized in that the distance between neighboring depressions or recesses decreases in the direction to the end of the area of reduced strength. Since, according to the invention, the end section entering a pipe to be connected therewith, or at least one end section of a joining element inserted between two pipes to be connected with each other, is formed with an area of reduced strength with several depressions or recesses, relative to an adjoining subarea, it is ensured that, even in the event of an eccentric stress acting in the region of the pipe connection between the first pipe and the second pipe, and a thus caused contact between the inwardly located end section and the outwardly located jacket area of the overlapping end section, the integrity of the connection will be maintained in this area with, in particular, a destruction of, or damage to, the surrounding end section, or the jacket area of the latter, being avoided. In the event of forces or stresses acting or extending transversely or inclinedly to the longitudinal axis of the pipe connection, and the resulting tilting or inclining of the adjoining pipes or pipe elements, the inwardly located end section will contact the surrounding end section, yet it will be safeguarded by the area of reduced strength facing the interior of the pipe that this area of reduced strength will be accordingly deformable such that the end section, or jacket section of the surrounding pipe, will remain intact. The depressions or recesses providing said reduced strength can be produced in a very simple and reliable manner. In order to provide an area of reduced strength in the end section or end portion facing the pipe interior at a constant material cross section of the pipes to be connected, or a joining element to be inserted in the respective end section of the pipes to be connected, by keeping production as simple as possible and production costs accordingly low, it is provided that the area of reduced strength is provided with a plurality of depressions or recesses on its inner circumference. In order to achieve an accordingly progressive reduction of strength in the direction to the free end of the received end section, it is proposed according to the invention that the distance between neighboring depressions or recesses decreases in the direction to the end of the area of reduced strength. According to a preferred embodiment, it is proposed that the area of reduced strength is realized as an area of reduced material thickness, thus preserving the integrity of the pipe connection by a simplified production.

In order to prevent the area of reduced strength of the inwardly located end section from cutting into the surrounding end section or jacket area, it is proposed according to a further preferred embodiment that the area of reduced strength is designed to be rounded off towards its free end on its outer surface. Such a rounding-off on the free end is simple to produce and enables the safe avoidance of damage to inner circumference of the surrounding end section.

If eccentric forces, or forces extending or acting obliquely or transversely to the longitudinal direction of the pipe connection, occur in the region of a pipe connection, it is to be anticipated that the free end of the received end section is being deformed as the adjoining pipes or pipe elements are tilted the farthest out of their aligned position. In order to provide the outermost end section with an accordingly reduced strength, or provide an, in particular, uniformly or steadily changing strength, by simple measures, it is contemplated according to a further preferred embodiment that a plurality of depressions or recesses is provided, whose widths and/or depths increase in the direction to the free end of the area of reduced strength. Due to the fact that, according to the invention, the widths and/or depths of the provided depressions or recesses increase towards the free end of the area of reduced strength, it is ensured that the subarea inserted most deeply into the surrounding pipe is formed with the accordingly smallest strength.

As already indicated above, it is possible to directly connect a first pipe and a second pipe, wherein, in this case, the ends of the pipes to be connected have to be designed accordingly differently in order to ensure that one end section will be overlapped by the end section of the pipe to be connected with the other pipe. In particular, with a view to enabling a simple production of the individual pipes or pipe elements to be connected, without having to take into account different embodiments of adjoining ends, or ends to be connected, it is known to respectively insert joining elements in end sections of pipes to be connected, which joining elements have accordingly short lengths and enable the simple and reliable connection of adjoining pipes. In this context, it is proposed according to a further preferred embodiment of the invention that the joining elements, which are each insertable into a respective end section of the pipes to be connected, are comprised of sleeve elements provided with fastening elements, in particular an internal thread and a complementary external thread, on their ends each projecting out of the pipe. Such sleeve elements are not only simple to produce, but, for instance, also enable pipes or pipe elements to be connected and optionally having extreme lengths to be designed in an accordingly thin-walled manner, since the elevated material cross section to be otherwise provided for a proper connection of adjoining pipes or pipe elements is not required. In addition, it is feasible, as already indicated above, to simplify the production of the individual pipe elements to be connected with each other, since no measures need be taken in the end sections to provide matching end sections in order to ensure the overlap required for a proper connection, of the end section to be connected.

For a particularly simple and reliable fixation of the joining elements, it is, moreover, proposed that the sleeve elements each comprise a stop extending, in particular, over the entire circumference and limiting the insertion depth of the sleeve element into the respective pipe, said sleeve element in the region of the stop being connectable with the pipe by a weld extending, in particular, over the entire circumference.

As already indicated above, such pipe connections may possibly be exposed to large and, in particular, eccentric stresses such that, in order to increase the safety of the fixation of the joining elements in the individual pipes or pipe elements, it is, moreover, proposed that breakthroughs or passage openings are provided at a distance from the end of the pipe in a manner distributed about its circumference, through which an additional weld is formed with the inserted sleeve element, as in correspondence with a further preferred embodiment of the pipe connection according to the invention.

In the following, the invention will be explained in more detail by way of exemplary embodiments schematically illustrated in the accompanying drawing. Therein:

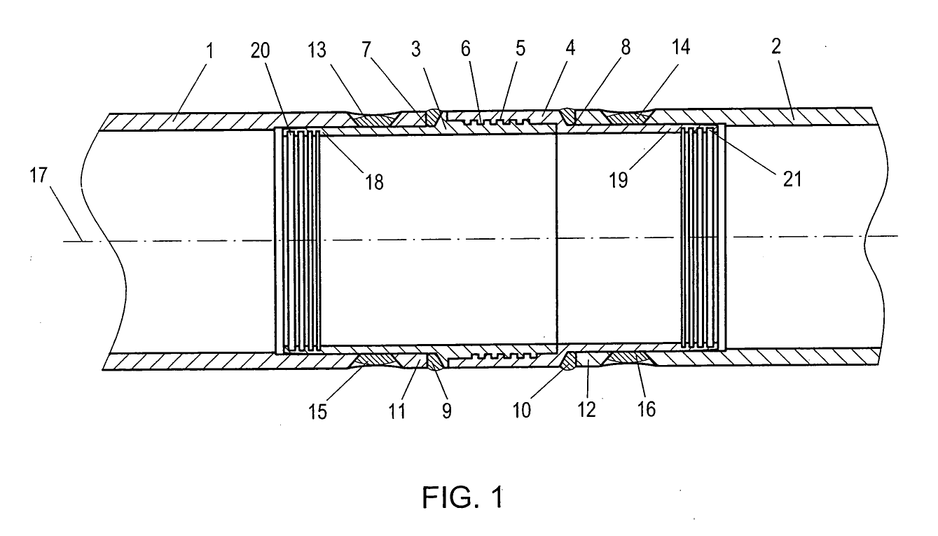

FIG. 1 is a schematic, partial section through a first embodiment of a pipe connection according to the invention;

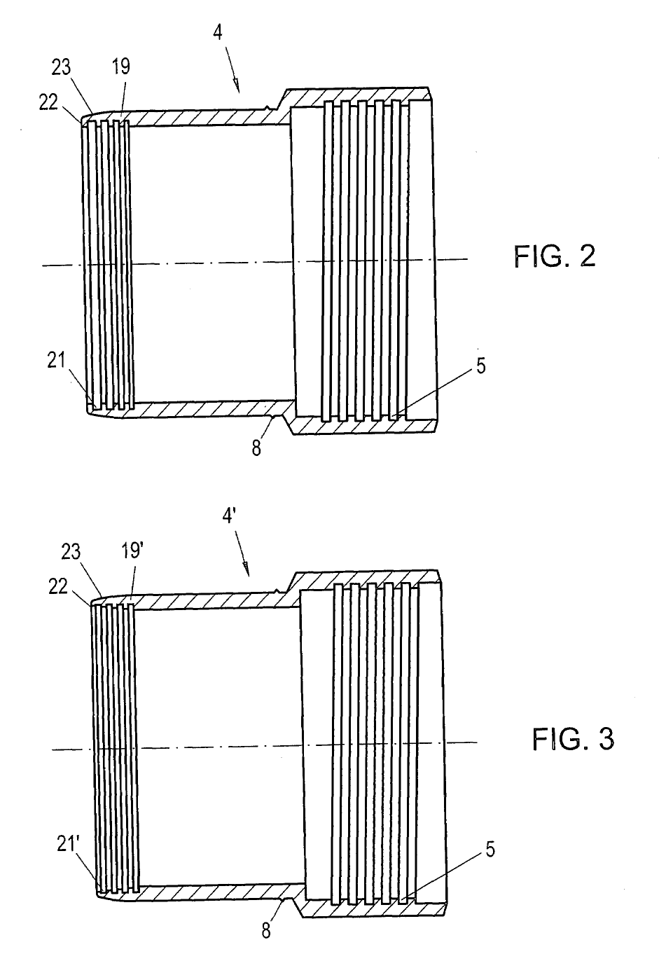

FIG. 2, on an enlarged scale, illustrates a joining element inserted in a pipe according to the configuration of FIG. 1;

FIG. 3 in an illustration similar to that of FIG. 2 depicts a modified embodiment of a joining element; and

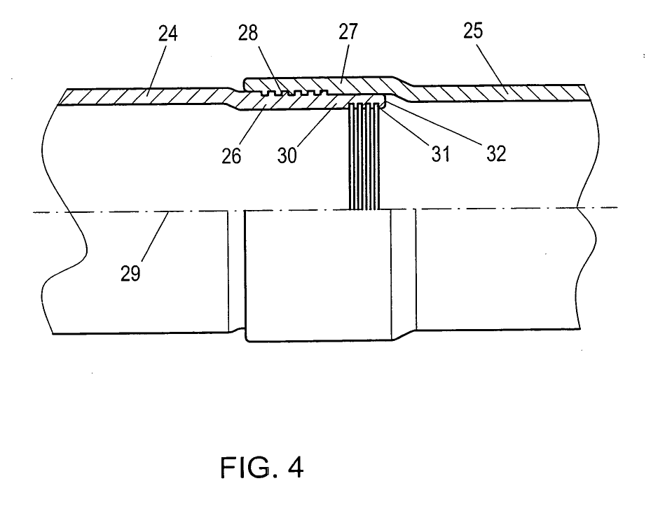

FIG. 4 is a partial section through a modified embodiment of a pipe connection according to the invention, with a first an second pipe being directly connected with each other.

FIG. 1 depicts a first pipe 1, which is to be connected with a pipe denoted by 2. To connect pipe 1 with pipe 2, a joining element comprised of a sleeve element 3 or 4, respectively, is each inserted in the respective pipes 1 or 2, said sleeve or joining element 3 and 4 being connectable with each other by a thread connection schematically denoted by 5 and 6, respectively.

Each of the joining elements or sleeve elements 3 and 4 is inserted in the final or end section of pipe 1 and 2, respectively, wherein a stop 7 or 8 is provided on the outer circumference of the respective joining element 3 or 4 in order to limit the insertion movement of the sleeve or joining elements 3 and 4. In the region of the stops 7 and 8, a weld schematically indicated by 9 and 10, respectively, is formed with the respectively inserted sleeve or joining element 3 and 4, along the periphery of the respective free end of pipes 1 and 2.

To assist the fixation of the sleeve or joining elements 3 and 4 in the respective one of pipes 1 and 2, openings or holes 13 and 14 are, in addition, respectively provided within the pipes 1 and 2 in a spaced-apart relationship from the respective free end 11 or 12, respectively, via which openings or holes additional connections between pipes 1 and 2 with the respectively inserted sleeve elements 3 and 4 are formed by welds schematically indicated by 15 and 16, respectively.

In order to prevent the overlapped end sections of the sleeve elements 3 and 4 from damaging the jackets of pipes 1 and 2 during a relative tilting or inclination of the pipes 1 and 2 under the action of forces transverse or perpendicular to the longitudinal axis 17 of the pipes 1 and 2, the end sections 18 and 19 of the respective sleeve elements 3 and 4 are formed with areas of lower rigidity or reduced strength on the respective end facing the pipe interior. In the embodiment illustrated in FIG. 1, at least one and, in particular, a plurality of, depression(s) or recess(es) 20 and 21 are respectively provided in order to obtain said reduced strength, as will be explained in more detail with reference to the following Figures.

FIG. 2, on an enlarged scale, depicts the sleeve element 4, wherein the internal thread for connection with the sleeve element 3 (not illustrated) is again denoted by 5. As is apparent from FIG. 2, the end section 19 of the sleeve element 4 is provided with a plurality of depressions or recesses 21 each extending over the entire inner periphery of the sleeve element 4, the width of the recesses or depressions 21 each increasing in the direction to the free end 22. It is, therefore, safeguarded that the strength or rigidity of the end section 19 will progressively decrease in the direction to the free end 22 such that the end section 19 will become increasingly easier to deform in the direction to the free end 22 during tilting or inclining. In addition, it is apparent from FIG. 2 that the end section 19 is provided with a rounding-off 23 on its outer circumferential surface.

FIG. 2 further illustrates the stop 8, which delimits the insertion movement of the sleeve element 4 into the pipe element 2 (not illustrated).

From the modified embodiment of a sleeve element 4′ illustrated in FIG. 3, it is apparent that the depressions denoted by 21′ have identical widths, yet with their depths increasing in the direction to the free end 22 in order to ensure, in a manner similar to the embodiment according to FIG. 2, that the strength will progressively decrease in the end section 19 with the latter, thus, being increasingly deformable in the direction to the free end 22 so as to avoid damage to the inner jacket of the pipe 2 (not illustrated in detail).

From the schematic illustration according to FIG. 4, it is apparent that a pipe 24 is directly connected with a second pipe 25, wherein the respective ends 26 and 27 of the pipes 24 and 25 to be connected with each other are accordingly designed to match each other in order to enable the end 26 to be overlapped by the end 27. For a detachable connection of the two pipes 24 and 25, a screwable thread connection 28 is again indicated in FIG. 4.

In order to prevent, in the embodiment illustrated in FIG. 4, that the outwardly located end section 27 of the pipe 25, during tilting or inclining, is damaged by the inwardly located end section 26 under the action of forces extending obliquely or transversely to the longitudinal axis 29, it is also provided in the embodiment represented in FIG. 4 that the end section 30 of the pipe 24, that faces the pipe interior is formed with reduced strength. In a manner similar to the preceding embodiments, a plurality of depressions or recesses 31 are again indicated to obtain said reduced strength. These recesses or depressions 31, in a manner similar to the preceding embodiment, may have different depths and/or widths or even be arranged at different distances from one another. Moreover, a rounded-off outer end section 32 is also provided in the embodiment illustrated in FIG. 4.

Instead of the configuration comprising depressions or recesses 20 and 21, or 31, for obtaining an area of reduced strength, or by reducing the material thickness as is, for instance, achievable by providing the rounded-off or bevelled end sections 23 or 32, a reduced strength of the end sections facing the interior of the pipes will be achieved by an appropirate material treatment of these subareas in order to provide an accordingly reduced strength.

While, in the embodiment illustrated in FIG. 4, the respective ends of the pipes 24 and 25 have to be designed with complementary end sections 26 and 27, respectively, in order to enable a direct connection, it is apparent from the embodiment illustrated in FIG. 1 that pipes or pipe elements 1 and 2 which are simple to produce and have uniform material cross sections over their entire lengths will do, wherein joining or sleeve elements 3 and 4, which are also simple to produce and insert, are provided for the connection, said joining or sleeve elements being also usable to provide the appropriate material thickness, in particular, in the region of the threads. These adjoining pipes or pipe elements 1 and 2 are not only simple to produce, but will usually also allow for a usually smaller material cross section, since no additional shaping or additional material cross section need be taken into account in order to provide a safe connection on the ends. It is, thus, also feasible to do with a reduced material input and reduced weight, in particular, with pipes or pipe elements having greater lengths.

1: A pipe connection between a first pipe and a second pipe, wherein an end section of one pipe is overlapped by an end section of the other pipe and/or a joining element is each inserted in the mutually facing end sections of the pipes, and wherein the pipes are, in particular, detachably connectable, preferably screwable, with each other, whereby the end section of the pipe overlapped by the other pipe, and/or at least one joining element inserted in an end section of a pipe, is formed with an area of reduced strength relative to an adjoining subarea on its end facing the interior of the pipe, wherein the area of reduced strength is provided with a plurality of depressions or recesses on its inner circumference, characterized in that the distance between neighboring depressions or recesses decreases in the direction to the end of the area of reduced strength.

2: The pipe connection according to claim 1, characterized in that the area of reduced strength is realized as an area of reduced material thickness.

3: The pipe connection according to claim 1, characterized in that the area of reduced strength is designed to be rounded off towards its free end on its outer surface.

4: The pipe connection according to claim 1, characterized in that a plurality of depressions or recesses is provided, whose widths and/or depths increase in the direction to the free end of the area of reduced strength.

5: The pipe connection according to claim 1, characterized in that the joining elements, which are each insertable into a respective end section of the pipes to be connected, are comprised of sleeve elements provided with fastening elements, in particular an internal thread and a complementary external thread, on their ends each projecting out of the pipe.

6: The pipe connection according to claim 5, characterized in that the sleeve elements each comprise a stop extending, in particular, over the entire circumference and limiting the insertion depth of the sleeve element into the respective pipe, said sleeve element in the region of the stop being connectable with the pipe by a weld extending, in particular, over the entire circumference.

7: The pipe connection according to claim 5, characterized in that breakthroughs or passage openings are provided at a distance from the end of the pipe in a manner distributed about its circumference, through which an additional weld is formed with the inserted sleeve element.
